(19) United States
(12) Patent Application Publication
(10) Pub. No.: US 2003/0004993 A1
(43) Pub. Date: Jan. 2, 2003

(54) System, method and computer program for the creation of web pages and communications between web pages

(76) Inventors: Randal F. Templeton, Flowar Mound, TX (US); Evan L. Merrill, Orem, UT (US); Kent J. Diamond, Highland, UT (US); Clayne B. Robison, American Fork, UT (US); Yuki Bernardi, Lehi, UT (US)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/892,633

(22) Filed: Jun. 28, 2001

(51) Int. Cl. G06F 17/24

(52) U.S. Cl. 707/513; 707/517

(57) ABSTRACT

A system, method and computer program for generating web pages and communicating between web pages. The generation of web pages entails the use of an XML repository that contains a web page template and associated applications handlers. The application handlers generate the parts of the web page which are combined to form a web page according to the template. A console engine is used to parse a incoming XML data element. The data contained in the incoming data element is used to update a web page and thereby communicate with it.

### FIELD

The invention relates to a system, method and computer program for the creation of web pages and communications between web pages. More particularly, the present invention enables the creation and storage of page segments in a repository and the creation of an entire web page from a template using the page segments contained in the repository. Further, once these web pages are created and executing, the invention enables communications among web pages and updating of segments of web pages in real-time.

### BACKGROUND

With the explosion in Internet access and usage, individuals have discovered and become dependent upon the availability of large amount of information as well and the ability to buy and sell goods and services via the Internet. A typical Internet user would have a browser installed in his personal computer (PC) or server such as Internet Explorer™ or Netscape™. Using this browser, the user may access an Internet service provider, such as America-On-Line (AOL™), via a modem over the local public switched telephone network (PSTN), a cable network or satellite link. Once logged onto an Internet web server, the user may utilize one of the many search engines, such as Yahoo™ or Lycos™, to specify search terms. The user could also log onto a web server and view the products or services available for sale or receive the information desired.

With this increased usage of the Internet has come a large demand for web page generation and web page designers and programmers. Web pages have typically been written in a hypertext markup language (HTML) in which locations of icons and entry fields for data are specified. Further, web pages may be instantiated (activated) from other web pages in a tree like structure from parent to child. Normally, in the creation of a web page, whenever a new web page is needed a new HTML script is generated for the entire page even if only a portion of the web page has changed from one done earlier. This has proven to be relatively costly in programmer time. Further, separate business applications software is normally required in order to enable a web site to operate properly. For example, if a web site accepts credit cards, then a separate program receives the credit card information entered by the client in the web page. If the requirements of the credit card processing software module change then so may the requirements for the web page. Thus, it may be necessary to generate a new HTML script for a new web page because of changes in the business applications software. Further, because of the hierarchical structure in execution of web pages, if a child web page requires execution of a parent web page, another copy of the parent web page has to be loaded into memory and executed. Therefore, significant time is involved in generating web pages and significant memory usage is required to execute web pages. Further, the execution process is delayed due to disk access or communication rate limitations each time a parent web page has to be re-loaded into memory.

Therefore, what is needed is a system, method, and computer program in which portions or parts of a web page can be generated and stored for retrieval and assembly as a single web page. This system, method and computer program would save development time since entire web pages would not have to be rewritten whenever a change in a segment of a web page occurs. Further, this system, method, and computer program should enable the passing of messages containing data for a part or an entire web page from parent to child and child to parent without the need to load the web page into memory if it already resides in memory. By being able to reuse web pages already in memory it is possible to save the time needed to access the web page and load it into memory on the web server, thereby providing a faster response time.

### BRIEF DESCRIPTION OF THE DRAWINGS

The foregoing and a better understanding of the present invention will become apparent from the following detailed description of exemplary embodiments and the claims when read in connection with the accompanying drawings, all forming a part of the disclosure of this invention. While the foregoing and following written and illustrated disclosure focuses on disclosing example embodiments of the invention, it should be clearly understood that the same is by way of illustration and example only and the invention is not limited thereto. The spirit and scope of the present invention are limited only by the terms of the appended claims.

The following represents brief descriptions of the drawings, wherein:

FIG. 1 is a tree structure diagram of web pages in an example embodiment of the present invention;

FIG. 2 is a modular configuration diagram of the modules involved in an example embodiment of the present invention;

FIG. 3 is a flowchart used to construct portions/parts of a web page into an entire web page using a template web page in an example embodiment of the present invention; and

FIG. 4 is a flowchart of the generation of a delimited token used to pass specific data from one web page to another in an example embodiment of the present invention.

### DETAILED DESCRIPTION

Before beginning a detailed description of the subject invention, mention of the following is in order. When appropriate, like reference numerals and characters may be used to designate identical, corresponding or similar components in differing figure drawings. Further, in the detailed description to follow, exemplary sizes/mod elsivalues/ranges may be given, although the present invention is not limited to the same. As a final note, well-known components of computer networks may not be shown within the FIGs. for simplicity of illustration and discussion, and so as not to obscure the invention.

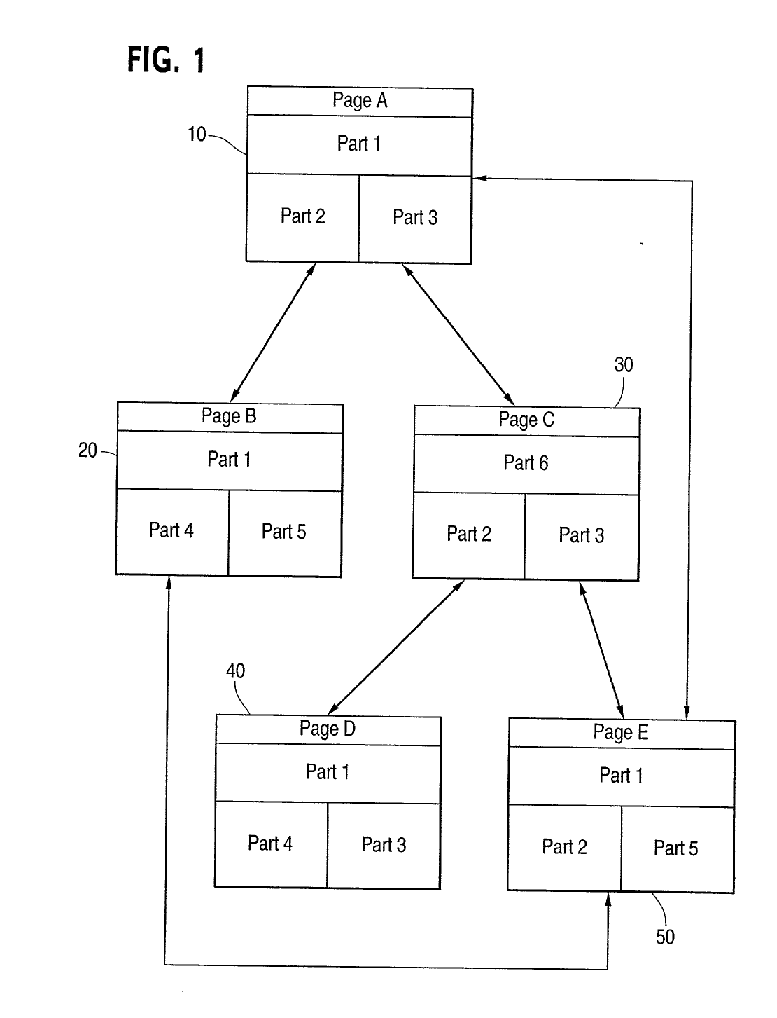

FIG. 1 is a tree structure diagram of web pages in an example embodiment of the present invention. The web pages illustrated FIG. 1 include Page A 10, Page B 20, Page C 30, Page D 40, and Page E 50. It should be noted in FIG. 1 that the web pages illustrated have common components or parts. For example, Page A 10 has parts 1, 2, and 3, whereas Page B 20 has part 1 in common with Page A 10 and has new parts 4 and 5. Additionally, Page C 30 has parts 2 and parts 3 in common with Page A 10, but has new part 6. It should also be noted that Page A 10 and Page E 50 are able to transmit data for display in each other's respective pages. This is also the case between Page B 20 and Page E 50. Further, whenever data is transferred from one page to another, if the page is in memory, then that page does not require re-loading and is able to be displayed with the new data contained therein.

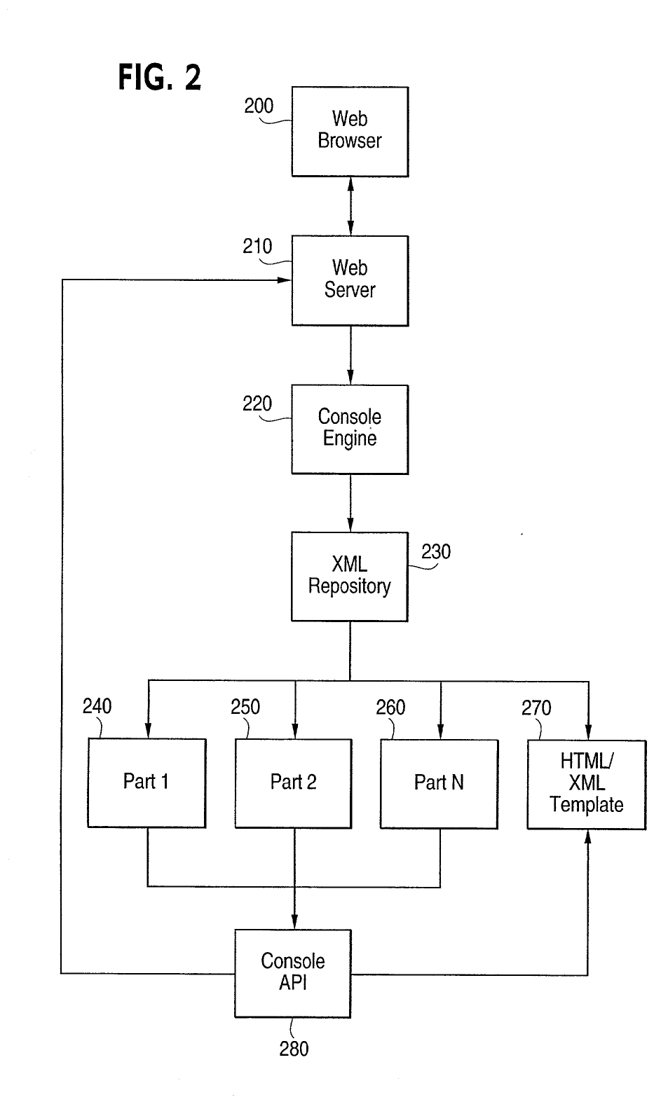

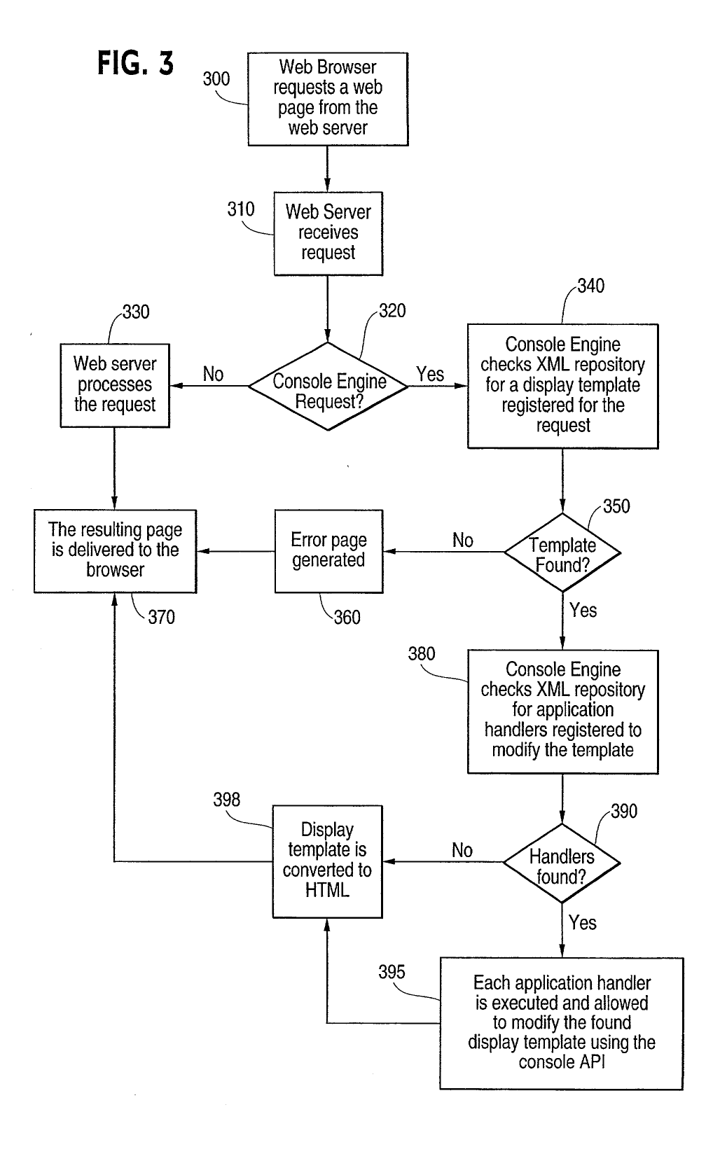

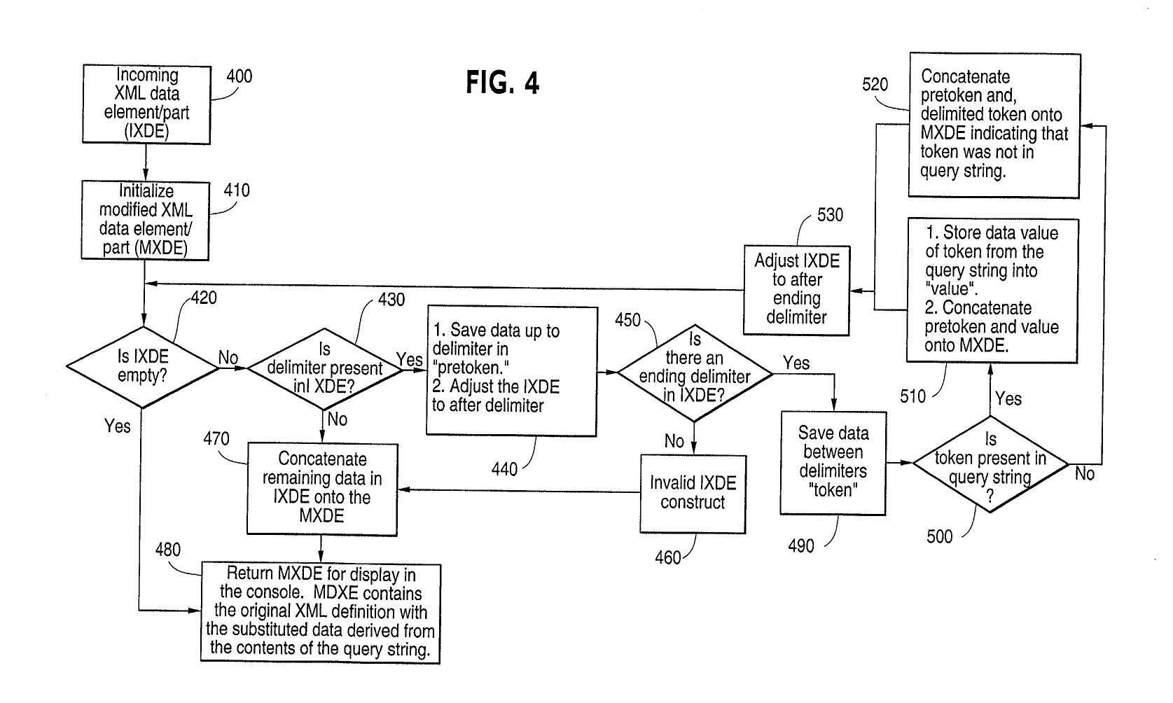

Before proceeding into a detailed discussion of the logic used by the embodiments of the present invention it should be mentioned that the flowcharts shown in FIGS. 3 and 4 as well as the modular configuration diagram shown in FIG. 2 contain software, firmware, hardware, processes or operations that correspond, for example, to code, sections of code, instructions, commands, objects, hardware or the like, of a computer program that is embodied, for example, on a storage medium such as floppy disk, CD Rom, EP Rom, RAM, hard disk, etc. Further, the computer program can be written in any language such as, but not limited to, for example C++. In the discussion of the flowcharts in FIGS. 3 and 4, reference will be simultaneously made to the corresponding software modules shown in FIG. 2.

FIG. 2 is a modular configuration diagram of the modules involved in an example embodiment of the present invention. The modules shown in FIG. 2 include a web browser 200, such as but not limited to, Internet Explorer™ or Netscape™. The web browser 200 would be in communications with a web server 210 which would in turn communicate with a console engine 220. The web browser 200 requests a particular page for display from the web server 210 which would in turn requests the console engine 220 to generate that particular web page. The console engine 220 would access an XML repository 230 containing portions or parts of web pages illustrated as part 1 240, part 2 250, and part N 260 as well as a HTML/XML template 270. The console engine 220 would assemble the web page desired according to the HTML/XML template 270 and the parts required as illustrated in FIG. 1. Thereafter, a console API (Application Program Interface) 280 would transmit the web page to the web server 210 for display by the web browser 200. The logic involved in the assembly of a web page from component parts is further detailed in the discussion of the flowchart illustrated in FIG. 3.

FIG. 3 is a flowchart used to construct portions/parts of a web page into an entire web page using a template web page in an example embodiment of the present invention. Processing begins in operation 300 where web browser 200 requests a web page from the web server 210. In operation 310, the web server 210 receives the request. Thereafter, in operation 320 it is determined whether this is a console engine 220 request. If this is a console engine 220 request, then processing proceeds to operation 340. In operation 340, the console engine 220 checks the XML repository 230 for a displaytemplate registered for the requested HTML/XML template 270. Processing then proceeds to operation 350 where it is determined if the template has been found in the XML repository 230. If the template has been found in the XML repository 230, then processing proceeds to operation 380. In operation 380, the console engine 220 checks the XML repository 230 for application handlers which are registered to modify the specific template. These application handlers are utilized to generate the individual parts 240 through 260, shown in FIG. 2. If such application handlers are found in operation 390, then processing proceeds to operation 395. In operation 395 each application handler is executed and allowed to modify the associated part within the display template using console API 280, shown in FIG. 2. Thereafter, in operation 398 the display of all template is converted to HTML format. Then in operation 370, the resulting Page is delivered to browser 200 for display.

Still referring to FIG. 3, if in operation 320 it is determined that this is not a console engine 220 request then processing proceeds to operation 330 where the web server 210 processes the request. Again processing then proceeds to operation 370 where the resulting web page is delivered to the web browser 200 for display.

Still referring to FIG. 3, if in operation 350 a template for the requested page cannot be found in the XML repository 230, then processing proceeds to operation 360 where an error page is generated.

Still referring to FIG. 3, if in operation 390 application handlers are not discovered in the XML repository 230 for the template then processing proceeds to operation 398. Again, in operation 398 the display template is converted to HTML format and processing proceeds to operation 370 where the resulting Page is delivered to the web browser 200 for display.

FIG. 4 is a flowchart of the generation of a delimited token used to pass specific data from one web page to another in an example embodiment of the present invention. This form of communication is illustrated in the example embodiment shown in FIG. 1. In FIG. 1, a parent or child page may transmit data to one another. Typically in order for data be transmitted between web pages they can only flow down a tree structure which occasionally requires the re-loading of a parent page when data is transferred to it by a child application. Further, this transmittal of data from one web page to another requires that information in at least part of a web page be modified for display purposes. This is accomplished through the logic illustrated in FIG. 4 by the web server 210 and console engine 220 shown in FIG. 2.

Referring to FIG. 4, execution begins in operation 400 where the web server 210 receives a delimited token containing an incoming XML data element (IXDE) from a web page. This delimited IXDE string would include, but not be limited to, such information as the source web page, the destination web page, and the data required for display. Thereafter, in operation 410 a modified XML data element/part (MXDE) is initialized. This MXDE will form an XML script containing the original web page template and parts along with the substituted data for display by the web browser 200. In operation 420, it is determined if the IXDE is empty. This operation is required since the console engine 220 is parsing the delimited string/token in operations 430-460 and 490-530. If the IXDE is not empty then processing proceeds to operation 430. In operation 430 it is determined if a delimiter is present 1, in the IXDE. The delimiter serves to indicate the beginning and ending of the IXDE and if a delimiter is present in the IXDE then processing proceeds to operation 440. In operation 440 the data starting from the delimiter is saved as a pre-token and the IXDE pointer is adjusted to after the delimiter. Thereafter, processing proceeds to operation 450 where it is determined if an ending delimiter is present in the IXDE. If there is no ending delimiter present in the IXDE then processing proceeds to operation 460 where it is determined that an invalid IXDE construct was received by the console engine 220. Thereafter, processing proceeds to operation 470 where the remaining data in the IXDE is concatenated to the MXDE. Processing then proceeds to operation 480 where the MXDE is returned for display by the console engine 220 to the web browser 200. This MXDE now contains the original XML definition (template) as well as the substituted data derived from the contents of the IXDE.

Still referring to FIG. 4, if in operation 450 it is determined that an ending delimiter is present in the IXDE then processing proceeds to operation 490. In operation 490, the data between the two delimiters, the beginning and ending delimiters, is saved as a “token.” Thereafter, processing proceeds to operation 500 where it is determined if the token is present within the query string. If the token is present in the query string then processing proceeds operation 510. In operation 510, the data contained in the token from the query string is stored as a temporary value. In addition, in operation 510, the pre-token created in operation 440 and the value are concatenated to form the MXDE. Thereafter, processing proceeds to operation 530 where the IXDE pointer is adjusted so that it points to after the ending delimiter. From operation 530 processing then proceeds to operation 420 as previously discussed.

Still referring to FIG. 4, if in operation 500 the token is not present within the query string then processing proceeds to operation 520. In operation 520 the pre-token and delimited token are concatenated onto the MXDE to indicate that the token was not found in the query string. Thereafter, processing proceeds operation 530 as previously discussed.

The benefit resulting from the present invention is that a simple, reliable system, method and computer program is provided for generating web pages and communicating between web pages. Using the present invention it is possible forweb page programmers to create portions of a web page which are assembled for display according to a template created. Further, re-loading of web pages is eliminated through the creation of IXDE which is parsed and utilized to create a new web page for display.

While we have shown and described only a few examples herein, it is understood that numerous changes and modifications as known to those skilled in the art could be made to the example embodiment of the present invention. Therefore, we do not wish to be limited to the details shown and described herein, but intend to cover all such changes and modifications as are encompassed by the scope of the appended claims.

We claim:

1. A system for generating and communicating to web pages, comprising:
a console engine to receive requests for web pages and messages to be sent to web pages; and
an XML repository connected to the console engine having a plurality of parts of web pages and a plurality of HTML/XML templates, wherein the console engine extracts a template for the requested web page, incorporates the parts for the web page required by the template to form the web page.

2. The system recited in claim 1, further comprising:
a web browser to request the web page from the console engine and display.

3. The system recited in claim 2, further comprising:
an XML repository to contain the plurality of parts of web pages, the plurality of HTML/XML templates and a plurality of application handlers.

4. The system recited in claim 3, further comprising:
a console API to transmit the web page to a web browser, wherein the console engine extracts the template from the XML repository and at least one application handler, said at least one application handler generates a part of the web page and incorporates that part into the template.

5. The system recited in claim 2, wherein said console engine parses said message to identify delimiters contained in the message, the source web page, the destination web page, and data contained in the message.

6. The system recited in claim 5, wherein said console engine concatenates the data from the message with the template to create a modified XML data element that is displayed the web browser.

7. A method of generating a web page, comprising:
receiving a request for a web page from a web browser;
accessing an XML repository for a template for the web page and application handlers associated with the template;
executing the application handlers to generate a plurality of parts for the web page;
combining the plurality of parts for web with the template to form the web page; and
transmitting the web page to the web browser for display.

8. The method recited in claim 7, wherein said transmitting the web page to a web browser for display is done by a console API.

9. The method recited in claim 8, further comprising:
converting the template after combining the plurality of parts for the web page with the template to form the web page into HTML so as to be displayed by the browser.

10. A computer program for generating a web page, comprising:
receiving a request for a web page from a web browser;
accessing an XML repository for a template for the web page and application handlers associated with the template;
executing the application handlers to generate a plurality of parts for the web page;
combining the plurality of parts for the web page with the template to form the web page; and
transmitting the web page to the web browser for display.

11. The computer program recited in claim 10, wherein said transmitting the web page to a web browser for display is done by a console API.

12. The computer program recited in claim 11, further comprising:
converting the template after combining the plurality of parts for the web page with the template to form the web page into HTML so as to be displayed by the browser.

13. A method of communicating between web pages, comprising:
receiving an incoming XML data element;
parsing the incoming XML data element based on delimiters to determine the source web page, the destination web page, and the data to be received by the destination web page;
creating a pretoken from the data in the incoming XML data element;
concatenating the pretoken to a token to form a modified XML data element; and
displaying the modified XML data element using a web browser.

14. The method recited in claim 13, wherein incoming XML data element is a portion of a web page in which that data to be displayed is changing and said token an existing web page.

15. The method recited in claim 14, wherein said modified XML data element is the web page to be displayed.

16. A computer program for communicating between web pages, comprising:
receiving an incoming XML data element;
parsing the incoming XML data element based on delimiters to determine the source web page, the destination web page, and the data to be received by the destination web page;
creating a pretoken from the data in the incoming XML data element;
concatenating the pretoken to a token to form a modified XML data element; and
displaying the modified XML data element using a web browser.

17. The computer program recited in claim 16, wherein incoming XML data element is a portion of a web page in which that data to be displayed is changing and said token is an existing web page.

18. The computer program recited in claim 17, wherein said modified XML data element is the web page to be displayed.
